(19) United States
(12) Patent Application Publication
(10) Pub. No.: US 2017/0108631 A1
(43) Pub. Date: Apr. 20, 2017

(54) BAND-PASS FILTER

(71) Applicant: Asahi Glass Company, Limited, Chiyoda-ku (JP)

(72) Inventors: Masahiro MURAKAWA, Tokyo (JP); Masahiro MORI, Shizuoka (JP); Kageyuki SATOU, Shizuoka (JP)

(73) Assignee: Asahi Glass Company, Limited, Chiyoda-ku (JP)

(21) Appl. No.: 15/390,919

(22) Filed: Dec. 27, 2016

Related U.S. Application Data
(63) Continuation of application No. PCT/JP2015/068425, filed on Jun. 25, 2015.

(30) Foreign Application Priority Data
Jun. 30, 2014 (JP) 2014-134852

(51) Int. Cl. G02B 5/28

(52) U.S. Cl. CPC G02B 5/288; G02B 5/281

(57) ABSTRACT

The present invention relates to a band-pass filter containing a plurality of films, having a reflective band centered on a predetermined wavelength λ and having a transmission band in a part within the reflective band, in which the band-pass filter further contains an additional layer formed of two continuous layers of a high refractive index film with an optical film thickness of λ/4.5 or less and a low refractive index film with an optical film thickness of λ/4.5 or less, inserted in at least one boundary out of boundaries of the plurality of films.

### TECHNICAL FIELD

The present invention relates to a band-pass filter which is formed of a plurality of films, has a reflective band which has a predetermined wavelength λ in the center, and has a transmission band in a part of the reflective band.

### BACKGROUND ART

In general, band-pass filters are conventionally used in imaging devices, communication devices or the like in order to selectively block or transmit a wavelength in a predetermined wavelength band according to the usage or functions thereof.

Then, as such a band-pass filter, there is known one in which a transmission prevention band centered on a predetermined wavelength is set to be reflected by using reflective layers formed of a plurality of films with different refractive indices and a transmission band centered on a predetermined wavelength is obtained in the transmission prevention band by providing a spacer layer between the reflective layers to cause interference between the transmission and reflection (for example, refer to Patent Document 1).

The known band-pass filter has reflective layers formed of a plurality of films with an optical film thickness of λ/4 having different refractive indices in which the films are alternately arranged. The reflective layers arc formed to reflect light in a wide band including a predetermined wavelength λ and are formed to selectively transmit a transmission band centered on the predetermined wavelength λ by providing a spacer layer with an optical film thickness of λ/2 between a plurality of reflective layers to cause interference between the transmission and reflection.

### PRIOR ART DOCUMENTS

### Patent Document

[Patent Document 1] JP-A-2003-177237

### SUMMARY OF THE INVENTION

### Problems that the Invention is to Solve

However, with reflective layers for a long wavelength such as infrared rays, it is necessary to form each film to be thick and, in particular, the spacer layer with an optical film thickness of λ/2 is thick. Therefore, the stress balance in each film or with adjacent films is easily lost due to the thickness of each film and as a whole, and there is a concern that film separation or damage on films themselves will occur.

This is more remarkable as the number of layers is increased.

In addition, it is possible to set the transmission band, which is in the center of the transmission prevention band of the band-pass filter, at a position other than the center by changing the film thickness of the spacer layer. At this time, the optical film thickness of the spacer layer is changed, but there is a problem in that the transmittance of the transmission band is deteriorated.

Thus, the present invention is to solve the problem described above and has an object of providing, by thinning the films, a band-pass filter in which film separation or damage on the films themselves is prevented and which is able to suppress deterioration in the transmittance of a transmission band which is a part within the transmission prevention band (reflective band), even when setting the transmission band at an arbitrary position in the transmission prevention band.

### Means for Solving the Problems

The band-pass filter according to the present invention contains a plurality of films, and has a reflective band centered on a predetermined wavelength λ and a transmission band in a part within the reflective band, and solves the problem above by inserting an additional layer, which is formed of two continuous layers of a high refractive index film with an optical film thickness of λ/4.5 or less and a low refractive index film with an optical film thickness of λ/4.5 or less, in at least one boundary out of the boundaries of the plurality of films.

### Advantageous Effects of the Invention

According to the band-pass filter of the present invention, an additional layer, which is formed of two continuous layers of a high refractive index film with an optical film thickness of λ/4.5 or less and a low refractive index film with an optical film thickness of λ/4.5 or less with respect to a predetermined wavelength λ which is equivalent to the center of the reflective band, is inserted in at least one boundary. This makes it possible to reduce the overall thickness as the additional layer is inserted in place of a thick film over the entire band-pass filter.

In addition, in the case of setting the transmission band at a position other than the center within the reflective band, the additional layer which is inserted as a spacer layer may be made thick. This makes it possible to reduce thick films as compared with the related art and to suppress increases in the overall thickness.

Accordingly, film separation or damage on the films themselves can be suppressed.

Furthermore, one characteristic in the case of setting the transmission band at a position other than the center within the reflective band is that deterioration in the transmittance of the transmission band can be suppressed by changing the film thickness of the additional layer which is inserted as a spacer layer.

As an aspect of the band-pass filter of the present invention, it is possible to further reduce the overall thickness by, for example, inserting additional layers in an arbitrary plurality of the boundaries out of the boundaries.

In addition, it is also possible to individually change the characteristics of each of the additional layers which are inserted in the plurality of boundaries and it is possible to make band-pass filters with more diverse and preferable characteristics.

As an aspect of the band-pass filter of the present invention, for example, two or more sets of additional layer may be continuously inserted in an arbitrary boundary. This also makes it possible to individually change the characteristics of each of the two or more sets of the continuously inserted additional layers and to make band-pass filters with more diverse and preferable characteristics.

As an aspect of the band-pass filter of the present invention, for example, the additional layers may be inserted in a boundary which is interposed between two metal films. This makes it possible to suppress separation since the thickness of the two continuous layers is reduced, even when the two continuous layers are formed of materials with physical properties greatly different from those of the metal films.

In addition, one characteristic in the case of setting the transmission band at a position other than the center is that deterioration in the transmittance of the transmission band can be suppressed by changing the film thickness of the additional layer which is inserted as a spacer layer.

As an aspect of the band-pass filter of the present invention, for example, at least one set of the additional layer may be inserted in a plurality of boundaries which are interposed between two metal films. This also makes it possible to further individually change the characteristics of each of the additional layers and to make band-pass filters with more preferable characteristics.

As an aspect of the band-pass filter of the present invention, for example, the band-pass filter may be imparted with a characteristic capable of transmitting a specific band in one or both sub-transmission bands on a shorter wavelength side and a longer wavelength side than the wavelength λ. This makes it possible to obtain the equivalent characteristics as in the case of using a plurality of overlaying band-pass filters, in one band-pass filter.

As an aspect of the band-pass filter of the present invention, for example, the sub-transmission band may be a visible light band, and a first wavelength band on a longer wavelength side than the visible light band has, from the shorter wavelength side, a first transmission prevention band exhibiting transmission prevention characteristics, a transmission band, and a second transmission prevention band exhibiting transmission prevention characteristics. This makes it possible to obtain an optical filter with a characteristic of transmitting a visible light band and one or both sub-transmission bands on the short wavelength side and the long wavelength side thereof without overlaying a plurality of band-pass filters.

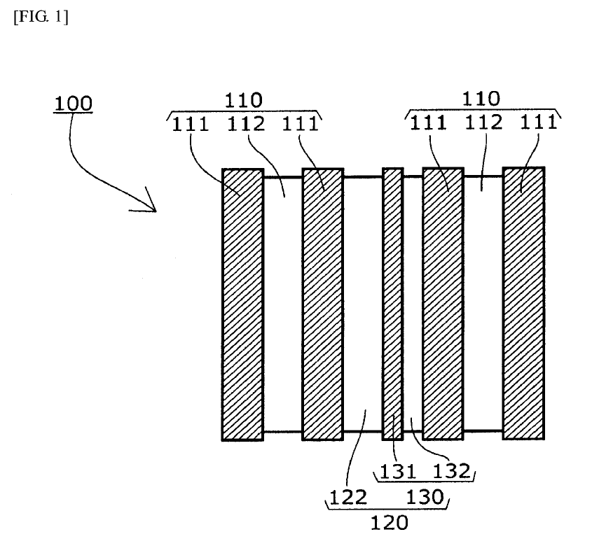

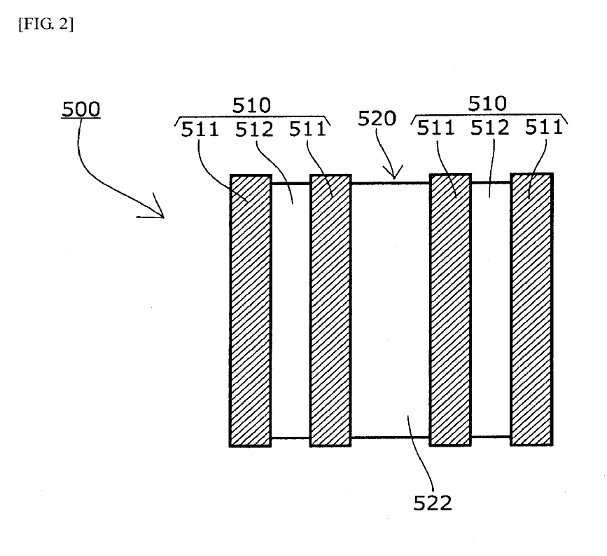

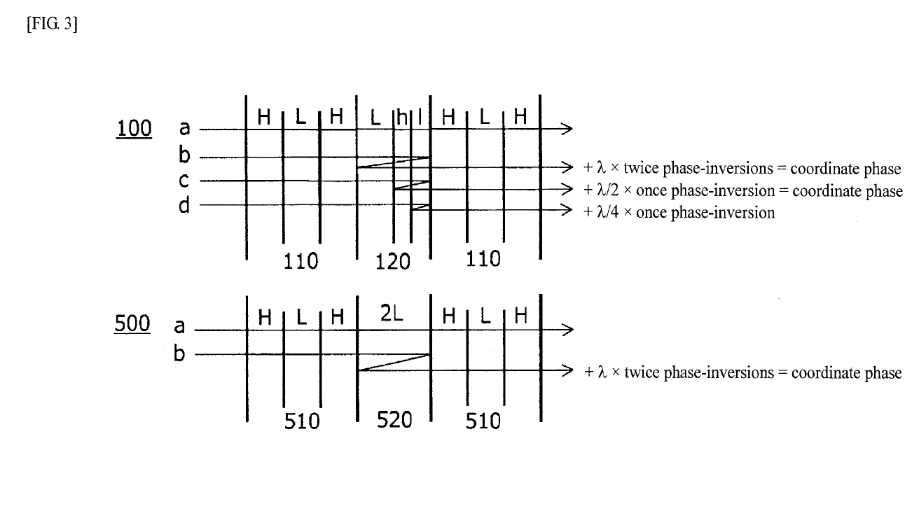

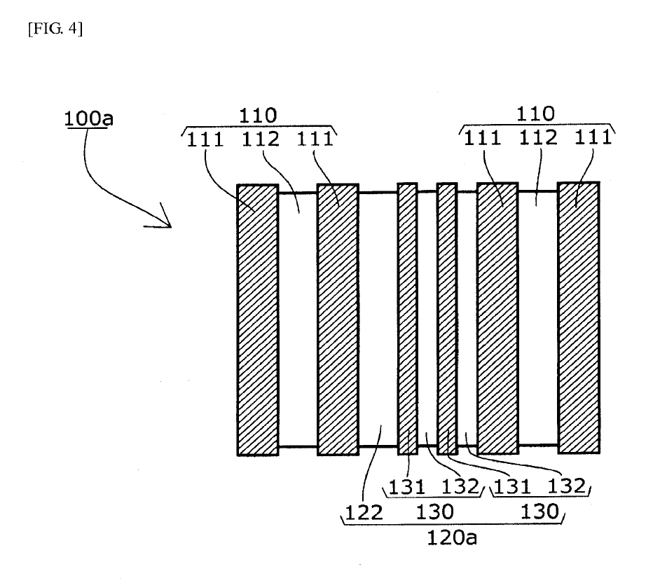

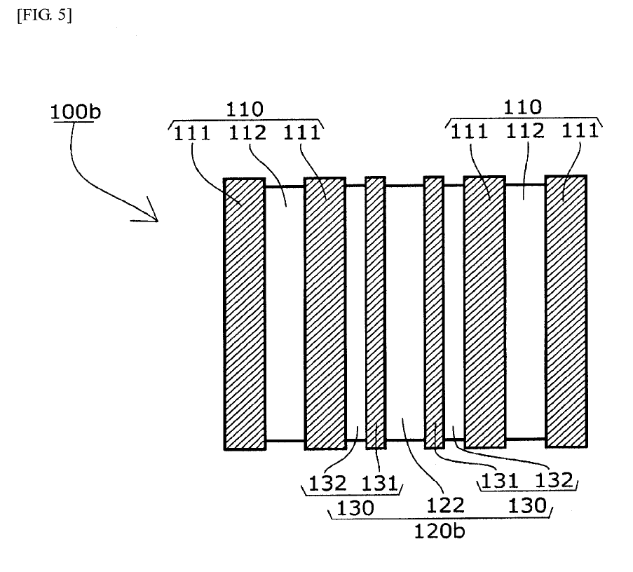

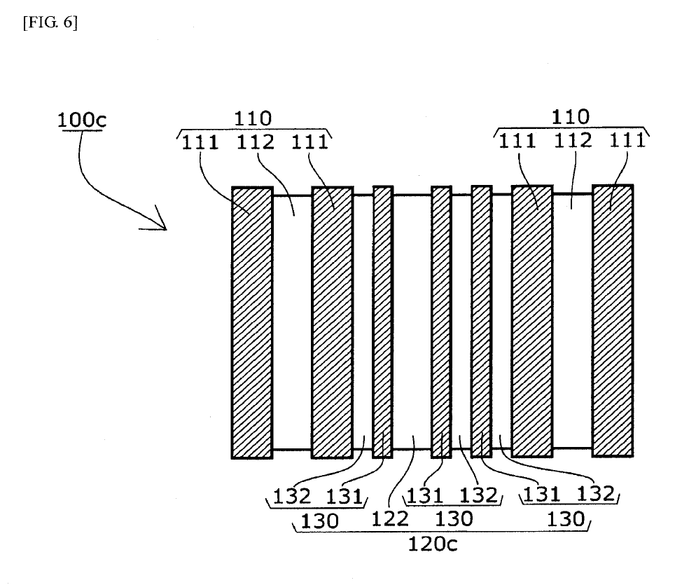

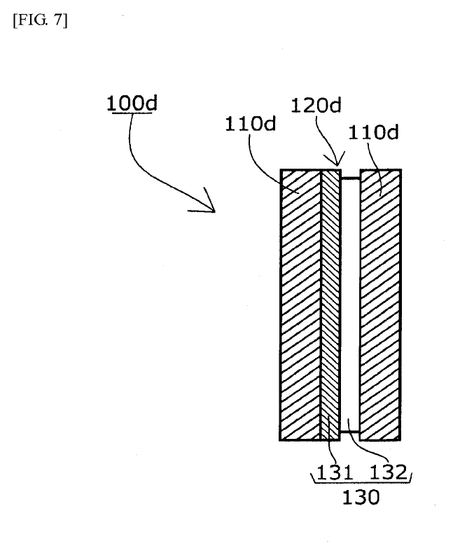

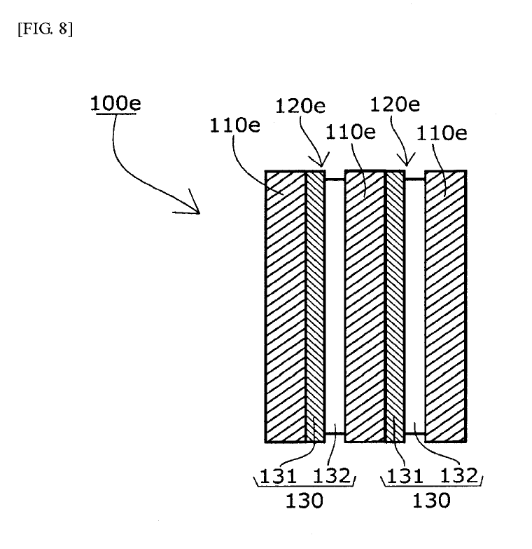

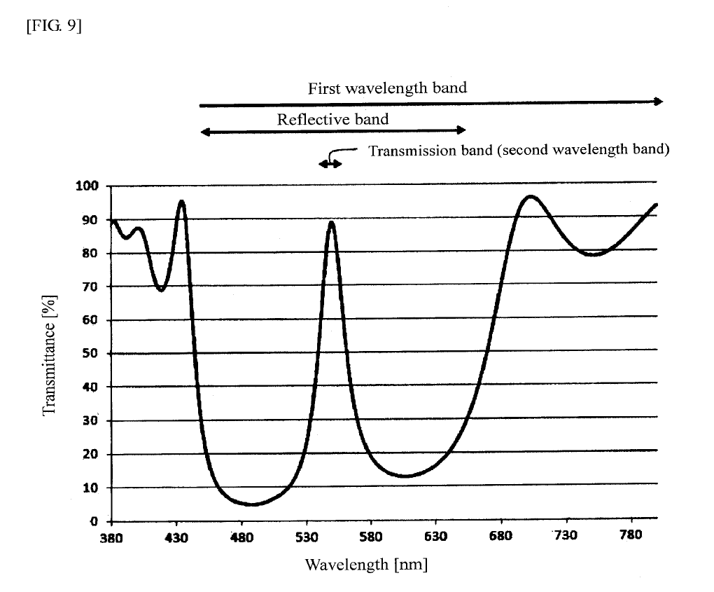

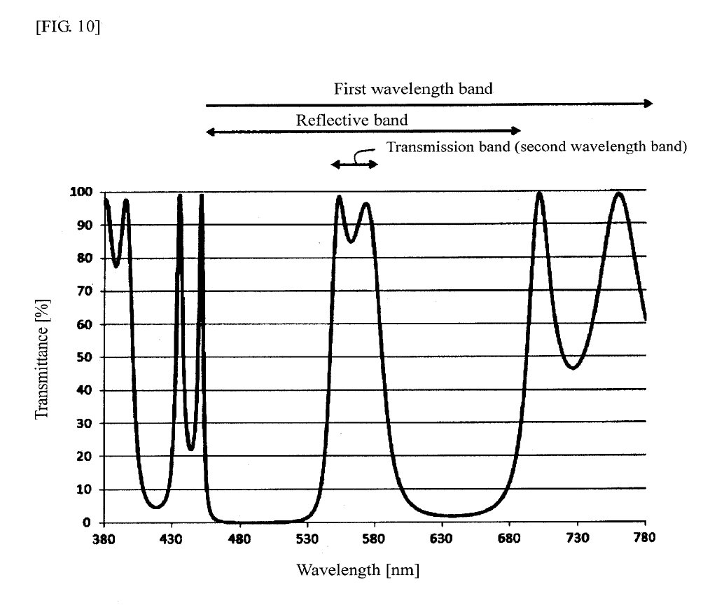

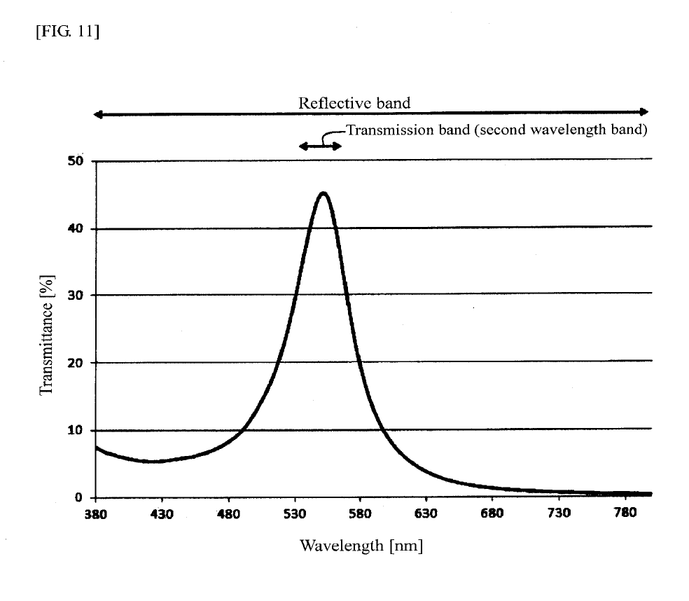

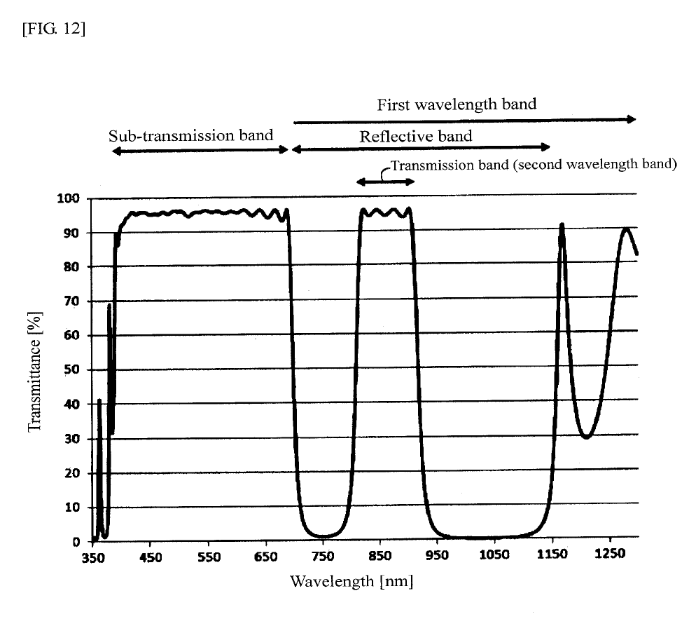

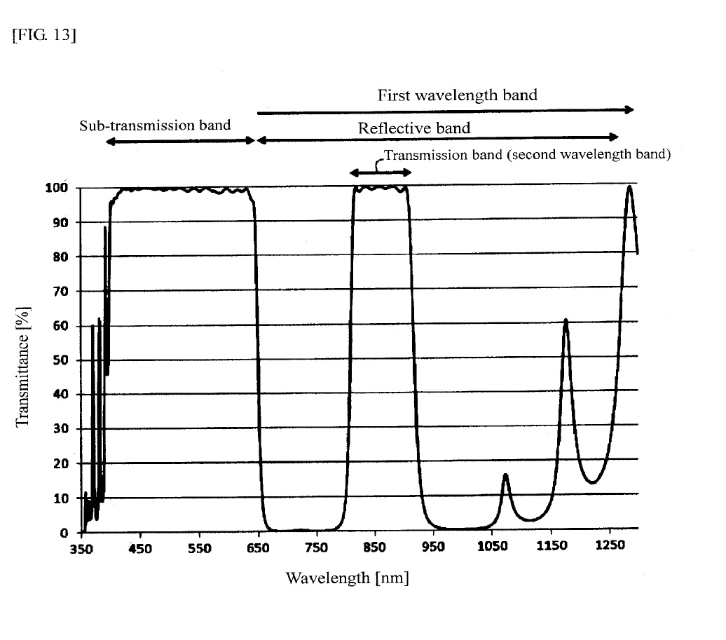

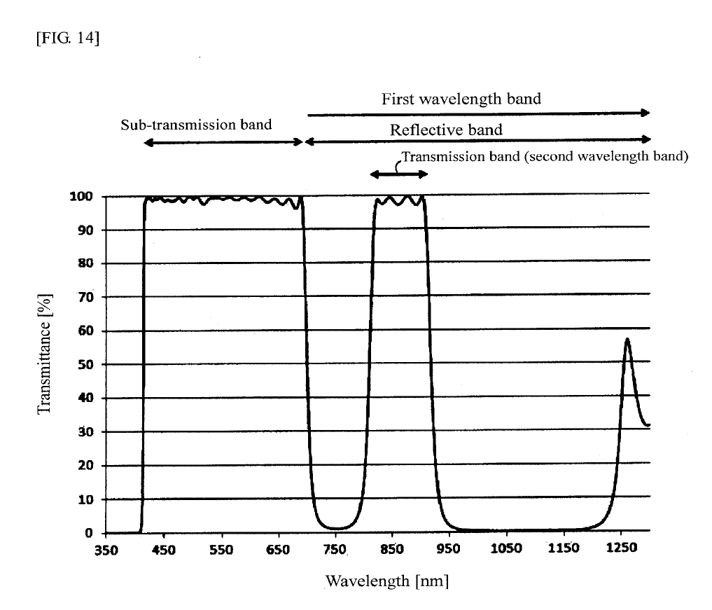

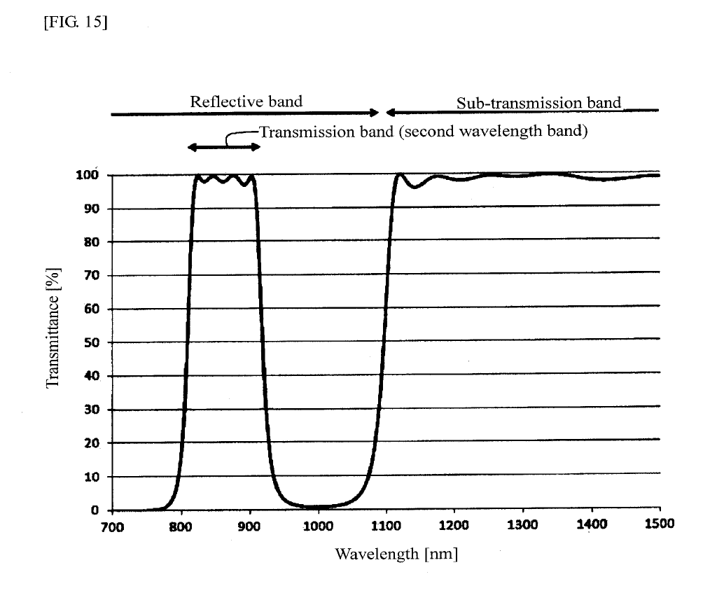

### BRIEF DESCRIPTION OF THE DRAWINGS

[FIG. 1] FIG. 1 is an explanatory diagram of a band-pass filter according to a first embodiment of the present invention.

[FIG 2] FIG. 2 is an explanatory diagram of a band-pass filter in the related art.

[FIG 3] FIG. 3 is an explanatory diagram of transmission of the band-pass filter according to the first embodiment of the present invention and the band-pass filter in the related art.

[FIG 4] FIG. 4 is an explanatory diagram of a band-pass filter according to a second embodiment of the present invention.

[FIG 5] FIG. 5 is an explanatory diagram of a band-pass filter according to a third embodiment of the present invention.

[FIG 6] FIG. 6 is an explanatory diagram of a band-pass filter according to a fourth embodiment of the present invention.

[FIG 7] FIG. 7 is an explanatory diagram of a band-pass filter according to a fifth embodiment of the present invention.

[FIG 8] FIG. 8 is an explanatory diagram of a band-pass filter according to a sixth embodiment of the present invention.

[FIG. 9] FIG. 9 is a graph of characteristics of the band-pass filter according to the second embodiment of the present invention.

[FIG. 10] FIG. 10 is a graph of characteristics of the band-pass filter according to the fourth embodiment of the present invention.

[FIG. 11] FIG. 11 is a graph of characteristics of the band-pass filter according to the fifth embodiment of the present invention.

[FIG 12] FIG. 12 is a graph of characteristics of a band-pass filter according to a seventh embodiment of the present invention.

[FIG 13] FIG. 13 is a graph of characteristic of another band-pass filter according to the seventh embodiment of the present invention.

[FIG 14] FIG. 14 is a graph of characteristic of still another band-pass filter according to the seventh embodiment of the present invention.

[FIG 15] FIG. 15 is a graph of characteristics of a band-pass filter according to another embodiment.

### MODE FOR CARRYING OUT THE INVENTION

Specific embodiments of the band-pass filter of the present invention may take any form as long as the band-pass filter is formed of a plurality of films and has a reflective band centered on a predetermined wavelength λ and a transmission band in a part within the reflective band, in which an additional layer formed of two continuous layers of a high refractive index film with an optical film thickness of λ/4.5 or less and a low refractive index film with an optical film thickness of λ/4.5 or less is inserted in at least one boundary out of boundaries of the plurality of films, and it is possible to reduce the thickness even for a long wavelength, to suppress film separation or damage on the films themselves, and to suppress deterioration in the transmittance of the transmission band even when setting the transmission band at a position other than the center of the reflective band.

In the case where the band-pass filter has a plurality of spacer layers, the additional layer may be provided instead of an arbitrary spacer layer and additional layers may be provided instead of all the spacer layers.

In addition, the order of the high refractive index film and the low refractive index film of the additional layer may be appropriately switched according to the relationship of the refractive index of the films on both sides of the boundary at which the additional layer is inserted.

The predetermined wavelength λ is equivalent to the central wavelength of the reflective band when assuming the reflective band as described above.

Then, in the design of the band-pass filter, the wavelength λ is determined as a wavelength of a specific value and the optical film thickness of each film is specifically designed based on the wavelength λ.

In addition, the optical film thickness of the additional layer is set as λ/4.5 or less; however, the range of from λ/30 to λ/5 is more preferable for the reason of securing the transmittance of the transmission band at a part within the reflective band and/or the band width of the transmission band.

In addition, the additional layer may be designed to be λ/8.

Here, in the case where the optical film thickness of the additional layer is a value close to λ/4.5, the transmission band within the reflective band is positioned at a longer wavelength side than the central wavelength within the reflective band and, in the case where the optical film thickness is a value smaller than λ/8, the transmission band within the reflective band is positioned at a shorter wavelength side than the central wavelength within the reflective band.

Using this characteristic, it is possible to freely design the position of the transmission band of a part within the reflective band and it is possible to secure the high transmittance characteristics of the transmission band and the maintenance of a specific band width.

In addition, the band-pass filter of the present invention may have a spacer layer containing the reflective layer and the additional layer described above on/above one surface of the substrate.

Here, “on/above the substrate” is not limited to the aspect where multilayer films which have the spacer layer containing the reflective layer and the additional layer described above is formed on one main surface of the substrate to be adjacent to each other, but also includes a case of having another optical functional layer between one main surface of the substrate and a multilayer film which has the spacer layer containing the reflective layer and the additional layer described above. That is, the arrangement of the substrate and the multilayer films is not limited as long as the multilayer films containing the reflective layer and the additional layer described above are in one group.

In the case where the band-pass filter of the present invention contains a substrate, the substrate may be a transparent substrate and, in this case, for example, use can be made of glass, quartz glass, color glass, crystal, transparent resin, and the like. In addition, the substrate may be one where one imparting a characteristic of absorbing light with a specific wavelength is added in the substrate itself, for example, the substrate may be a substrate where a dye which absorbs light with a predetermined wavelength is added to a transparent resin.

As the material of the high refractive index film and the material of the low refractive index film described above, arbitrary materials can be selected as long as they are respectively a material exhibiting a high refractive index and a material exhibiting a low refractive index with respect to the wavelength λ described above.

Here, when the refractive index of the material of the high refractive index film with respect to the wavelength λ is put nH and the refractive index of the material of the low refractive index film with respect to the wavelength λ is put nL, the refractive index difference Δn(=|nH−nL|) is preferably 0.2 or more and more preferably 0.5 or more for the reason that the optical film thickness is not increased.

As for the material of the high refractive index film, for example, preferred is a material selected from TiO₂, Ta₂O₅, Nb₂O₅, HfO₂, Al₂O₃, ZrO₂, ZnS, Ge, and Si. As for the material of the low refractive index film, for example, preferred is a material selected from SiO₂, MgF₂, chiolite, and ZnS. Among these, for the reason that it is possible to make the refractive index difference large, a combination of TiO₂ as the material of the high refractive index film and SiO₂ as the material of the low refractive index film is preferable.

### Example 1

A band-pass filter 100 according to the first embodiment of the present invention contains a spacer layer 120 inserted between two reflective layers 110 as illustrated in FIG. 1.

The two reflective layers 110 are each formed by interposing a low refractive index film 112 with an optical film thickness of λ/4 between two high refractive index films 111 with an optical film thickness of λ/4.

The spacer layer 120 is formed by a low refractive index film 122 with an optical film thickness of λ/4 and an additional layer 130, and the additional layer 130 is formed as a film with an optical film thickness of λ/4.5 or less such that a high refractive index film 131 with an optical film thickness of λ/8 and a low refractive index film 132 with an optical film thickness of λ/8 are continuous with each other.

When representing the high refractive index film with an optical film thickness of λ/4 as H, the low refractive index film with an optical film thickness of λ/4 as L, the high refractive index film with an optical film thickness of λ/8 as h, and the low refractive index film with an optical film thickness of λ/8 as 1, the structure is:

HLHL+h1+HLH.

FIG. 2 is a configuration diagram of a band-pass filter 500 which illustrates the configuration of an example in the related art.

As illustrated in FIG. 2, the band-pass filter 500 in the related art which is fanned in the same manner as the band-pass filter 100 according to the first embodiment contains a spacer layer 520 inserted between two reflective layers 510, and the two reflective layers 510 are formed by interposing a low refractive index film 512 with an optical film thickness of λ/4 between two high refractive index films 511 with an optical film thickness of λ/4.

The spacer layer 520 is formed by only a low refractive index film 522 with an optical film thickness of λ/2.

When representing the high refractive index film with an optical film thickness of λ/4 as H, the low refractive index film with an optical film thickness of λ/4 as L, and the low refractive index film with an optical film thickness of λ/2 as 2L, the structure is:

HLH+2L+HLH.

As illustrated at the bottom stage in FIG. 3, in the band-pass filter 500 in the related art, when a wave with a wavelength of λ is incident, the wave which is reflected on the boundary between the reflective layer 510 at the back and the spacer layer 520 becomes a reflective wave (b-wave) due to the boundary between the spacer layer 520 and the reflective layer 510 in the front and is directed again to the boundary between the reflective layer 510 at the back and the spacer layer 520.

At this time, since the path length is increased by the wavelength λ and inversion of the phase when reflecting from a low refractive index film toward a high refractive index film occurs twice, the b-wave is a coordinate phase with a linearly advancing wave (a-wave).

A wave with a wavelength of λ is transmitted due to the interference of the a-wave and b-wave.

Contrary to this, as illustrated in the upper stage in FIG. 3, when a wave with a wavelength of λ is incident to the band-pass filter 100 according to the first embodiment, a wave which is reflected on the boundary between the reflective layer 110 at the back and the spacer layer 120 becomes a reflective wave (b-wave) due to the boundary between the spacer layer 120 and the reflective layer 110 in the front, a reflective wave (c-wave) due to the boundary between the low refractive index film 122 and the additional layer 130, and a reflective wave (d-wave) due to the boundary between the low refractive index film 132 and the high refractive index film 131 in the additional layer 130, and each is directed again to the boundary between the reflective layer 110 at the back and the spacer layer 120.

At this time, since the path length is increased by the wavelength λ and inversion of the phase when reflecting from a low refractive index film toward a high refractive index film occurs twice, the b-wave is a coordinate phase with a linearly advancing wave (a-wave).

In addition, since the path length is increased by the wavelength λ/2 and inversion of the phase when reflecting from a low refractive index film toward a high refractive index film occurs once, the c-wave is a coordinate phase with a linearly advancing wave (a-wave) in the same manner.

A wave with a wavelength of α is transmitted due to the interference of the a-wave, b-wave, and c-wave.

Here, since the path length is increased by the wavelength λ/4 and inversion of the phase when reflecting from a low refractive index film toward a high refractive index film occurs twice, the phase of the d-wave is shifted by λ/4 from the a-wave, b-wave, and c-wave; however, it is confirmed from experiments that the interference transmission is not influenced.

In addition, in the band-pass filter 500 in the related art, the shifting of the transmission band is performed by adjusting the optical film thickness of the spacer layer 520; however, at this time, the transmittance is decreased.

Contrary to this, in the band-pass filter 100 according to the present invention, it is possible to shift the transmission band by adjusting the optical film thickness of the low refractive index film 132 and the high refractive index film 131 of the additional layer 130 and the deterioration in the transmittance is also small during the shifting.

For this reason, the optical film thickness of the low refractive index film 132 and the high refractive index film 131 of the additional layer 130 can be adjusted up to a thickness of λ/4.5.

### Example 2

As illustrated in FIG. 4, a band-pass filter 100a according to the second embodiment of the present invention contains a spacer layer 120a inserted between the two reflective layers 110.

The two reflective layers 110 are each formed by interposing a low refractive index film 112 with an optical film thickness of λ/4 between two high refractive index films 111 with an optical film thickness of λ/4.

The spacer layer 120a is formed by a low refractive index film 122 with an optical film thickness of λ/4 and the two additional layers 130, and the additional layers 130 are formed such that a high refractive index film 131 with an optical film thickness of λ/8 and a low refractive index film 132 with an optical film thickness of λ/8 are continuous with each other.

When representing the high refractive index film with an optical film thickness of λ/4 as H, the low refractive index film with an optical film thickness of λ/4 as L, the high refractive index film with an optical film thickness of λ/8 as h, and the low refractive index film with an optical film thickness of λ/8 as 1, the structure is:

HLHL+h1h1+HLH.

In the band-pass filter 100a according to the second embodiment, as an example, the wavelength λ is set to 550 nm, TiO₂ of which a refractive index is 2.3 at the wavelength λ is used as a high refractive index film, and SiO₂ of which a refractive index is 1.46 at the wavelength λ is used as a low refractive index film. Then, when the optical film thickness is set as illustrated in FIG. 4 (i.e., HLHL+h1h1+HLH) in each of the high refractive index films and the low refractive index films, the spectral characteristics shown in FIG. 9 are obtained. In the case of the band-pass filter 100a according to the present embodiment, the central wavelength λ (=550 nm) of the reflective band is positioned within the transmission band.

### Example 3

As illustrated in FIG. 5, a band-pass filter 100b according to the third embodiment of the present invention contains a spacer layer 120b inserted between the two reflective layers 110.

The two reflective layers 110 are each formed by interposing a low refractive index film 112 with an optical film thickness of λ/4 between two high refractive index films 111 with an optical film thickness of λ/4.

The spacer layer 120b is formed by interposing a low refractive index film 122 with an optical film thickness of λ/4 between two additional layers 130, and the additional layers 130 are formed such that a high refractive index film 131 with an optical film thickness of λ/8 and a low refractive index film 132 with an optical film thickness of λ/8 are continuous with each other.

When representing the high refractive index film with an optical film thickness of λ/4 as H, the low refractive index film with an optical film thickness of λ/4 as L, the high refractive index film with an optical film thickness of λ/8 as h, and the low refractive index film with an optical film thickness of λ/8 as 1, the structure is:

HLH+1h+L+h1+HLH.

### Example 4

As illustrated in FIG. 6, a band-pass filter 100c according to the fourth embodiment of the present invention contains a spacer layer 120c inserted between the two reflective layers 110.

The two reflective layers 110 are each formed by interposing a low refractive index film 112 with an optical film thickness of λ/4 between two high refractive index films 111 with an optical film thickness of λ/4.

The spacer layer 120c is formed by interposing a low refractive index film 122 with an optical film thickness of λ/4 between two additional layers 130 and another additional layer 130 is further formed continuously. The additional layers 130 are formed such that a high refractive index film 131 with an optical film thickness of λ/8 and a low refractive index film 132 with an optical film thickness of λ/8 are continuous with each other.

When representing the high refractive index film with an optical film thickness of λ/4 as H, the low refractive index film with an optical film thickness of λ/4 as L, the high refractive index film with an optical film thickness of λ/8 as h, and the low refractive index film with an optical film thickness of λ/8 as 1, the structure is:

HLH+1h+L+h1h1+HLH.

In the band-pass filter 100c according to the fourth embodiment, as an example, the wavelength λ is set to 550 nm, TiO₂ of which a refractive index is 2.3 at the wavelength λ is used as a high refractive index film, and SiO₂ of which a refractive index is 1.46 at the wavelength λ is used as a low refractive index film. Then, when the optical film thickness is set as illustrated in FIG. 6 (i.e., HLH+1h+L+h1h1+HLH) in each of the high refractive index films and the low refractive index films, the spectral characteristics shown in FIG. 10 are obtained.

### Example 5

As illustrated in FIG. 7, a band-pass filter 100d according to the fifth embodiment of the present invention contains a spacer layer 120d inserted between two reflective layers 110d each formed of a single metal film.

In addition, in the band-pass filter 100d according to the present embodiment, as an example, the wavelength λ is set to 550 nm, TiO₂ of which a refractive index is 2.3 at the wavelength λ is used, and SiO₂ of which a refractive index is 1.46 at the wavelength λ is used as a low refractive index film.

The spacer layer 120d is formed by an additional layer 130 and the additional layer 130 is formed such that a high refractive index film 131 with an optical film thickness of λ/8 and a low refractive index film 132 with an optical film thickness of λ/8 are continuous with each other. Here, as for the metal film referred to here, it is sufficient as long as it is formed of material having a certain transmittance in at least the transmission band and has characteristics of making it possible to confirm a sufficient contrast between the transmission band and the transmission prevention band in the configuration of the band-pass filter 100d. In addition, it is possible to select various types of material for the material which is used for the metal film; however, for example, it is preferable to use Al or Ag after thinning the film to an extent allowing the transmission of a certain amount of light.

When representing the metal film as M, the high refractive index film with an optical film thickness of λ/8 as h, and the low refractive index film with an optical film thickness of λ/8 as 1, the structure is:

M+h1+M.

### Example 6

As illustrated in FIG. 8, a band-pass filter 100e according to the sixth embodiment of the present invention contains spacer layers 120e inserted in respective gaps between a plurality of reflective layers 110e each formed of a single metal film.

The spacer layer 120e is formed by an additional layer 130 and the additional layer 130 is formed such that a high refractive index film 131 with an optical film thickness of λ/8 and a low refractive index film 132 with an optical film thickness of λ/8 are continuous with each other.

When representing the metal film as M, the high refractive index film with an optical film thickness of λ/8 as h, and the low refractive index film with an optical film thickness of λ/8 as 1, the structure is:

. . . M+h1+M+h1+M . . .

As shown in FIG. 9, the band-pass filter 100a according to the second embodiment described above can obtain a transmission band (second wavelength band) with high transmittance in a first wavelength band including a transmission prevention band (reflective band).

The first wavelength band referred to here has the meaning of the band on a longer wavelength side than the wavelength with a transmittance of 30% or less and the transmission band (second wavelength band) has the meaning of a wavelength band with a transmittance of 60% or more when tracing the spectral characteristics from a short wavelength side to a long wavelength side in a reflective band which has a predetermined wavelength λ in the center.

“Obtaining a transmission hand in a first wavelength band” as described above has the meaning of, when based on the spectral characteristics in FIG. 9, having a transmission band (second wavelength band: from approximately 541 nm to approximately 558 nm) which has a specific band width in a band of approximately 448 nm or more (i.e., the first wavelength band in FIG. 9) although the transmittance is approximately 30% at approximately 448 nm.

As shown in FIG. 10, the band-pass filter 100e according to the fourth embodiment can obtain a transmission band having a certain width and having a comparatively high transmittance of which a rising phase is steep, in the first wavelength band including a transmission prevention band (reflective band).

In this case, when based on the spectral characteristics in FIG. 10, the meaning is to have a transmission band (second wavelength band: from approximately 548 nm to approximately 583 nm) which has a specific band width in the band with a long wavelength of approximately 454 nm or more (i.e., the first wavelength band in FIG. 10) although the transmittance is approximately 30% at approximately 454 nm. In the points that the band-pass filter 100e has steep rising phase/falling phase of the transmission band and high transmittance as compared with the band-pass filter 100a, the band-pass filter 100c may be more preferable in some cases as a band-pass filter for transmitting a specific wavelength band.

In the case of having the transmission band (in the first wavelength band), the transmittance of the transmission band may be 60% or more, more preferably 70% or more, and even more preferably 80% or more. Furthermore, the transmittances of the first transmission prevention hand on the short wavelength side of the transmission band and of the second transmission prevention band on the long wavelength side of the transmission band may be 30% or less, more preferably 20% or less, and even more preferably 10% or less.

As shown in FIG. 11, the band-pass filter 100d according to the fifth embodiment can obtain a transmission band (second wavelength band) with less noise in the first wavelength band including a wide transmission prevention band (reflective band).

In this case, when based on the spectral characteristics in FIG. 11, there is a transmission band (second wavelength band) having a specific band width, in a specific wavelength band (first wavelength band: 380 nm or more) with a wide range shown in FIG. 11. Here, in this case, the transmittance is approximately 45% at maximum; however, for example, when the maximum value of the transmittance is normalized as 100%, a wavelength band having a transmittance of 60% or more may be set as the transmission band (second wavelength band).

In addition, according to the band-pass filter of the present invention, it is possible to obtain the characteristics as shown in FIG. 12 as a whole by imparting a characteristic of transmitting at a specific band in a sub-transmission band on the shorter wavelength side than the first wavelength hand including a transmission prevention band (reflective band).

This can be obtained by setting a short pass filter in the transmission band filter, which the short pass filter has a reflective band including a transmission band of the transmission band filter, for example, by imparting a multilayer film structure containing a film with an optical film thickness of λ/8 in the outermost layer.

For example, it is possible to transmit through two regions of a visible light region and a specific infrared ray region with a band-pass filter in which multilayer films including reflective layers and additional layers are in one group.

The band-pass filter according to the seventh embodiment is an example of a plural-bands-pass filter which is designed to set the wavelength λ as approximately 940 nm by imparting the multilayer film structure of a short pass filter as described above.

The band-pass filter according to the present embodiment is designed such that high transmittance can be obtained in a visible light region, a reflective band is present on a longer wavelength side than the visible light region, and a transmission band centered on a wavelength of approximately 850 nm can be obtained with high transmittance.

When carrying out automated design under a restriction of including two continuous layers of a high refractive index film with an optical film thickness of λ/4.5 or less and a low refractive index film with an optical film thickness of λ/4.5 or less so as to be able to obtain these spectral characteristics as described above, provided is a structure of a multilayer film including an additional layer formed of two layers of a high refractive index film of λ/16 and a low refractive index film of λ/22 and another additional layer formed of two layers of a high refractive index film of λ/15 and a low refractive index film of λ/26.

In the band-pass filter according to the present embodiment, the central wavelength of the transmission region (second wavelength band) is present in the vicinity of approximately 850 nm and the band width where the transmittance is 60% or more is approximately 100 nm.

In addition, in FIG. 12, the long wavelength band of approximately 711 nm or more where the transmittance is 10% or less indicates the first wavelength band.

On the other hand, in FIG. 12, the transmittance is 60% or more in a band from approximately 390 nm to approximately 697 nm, a so-called sub-transmission band.

In this manner, in a band-pass filter in which multilayer films including reflective layers and additional layers are in one group, it is possible to realize a plural-bands-pass filter (dual band pass filter) which exhibits high transmittance in a visible light region that is a sub-transmission band and have a transmission band (second wavelength band) in a specific wavelength band in the first wavelength band.

When based on the spectral characteristics shown in FIG. 12, in particular, the band-pass filter according to the seventh embodiment exhibits high transmittance selectively in a visible light region as a sub-transmission band, and also has the first transmission prevention band, the transmission band (second wavelength band), and the second transmission prevention band from the shorter wavelength side in the first region which is adjacent to the visible light region. That is, the reflective band (transmission prevention band) includes the first transmission prevention band, the transmission band (second wavelength band), and the second transmission prevention band.

Here, since the transmission band (second wavelength band) has a band of approximately 100 nm centered on a wavelength of approximately 850 nm by making the optical film thickness of the additional layer thinner than λ/8, as described below, for example, the band-pass filter can be favorably used in an optical system such as a monitoring camera application.

As in the case of a monitoring camera, when imaging a target of which the surroundings are bright during the hours of daytime as an image for example, the transmittance of the visible light region is preferably high in order to increase the sensitivity with respect to the light of a wavelength of the visible light region.

On the other hand, for example, when imaging a target of which the surroundings are dark during the hours of night time as an image, a function which increases the sensitivity of an infrared ray region, as a so-called infrared ray camera is exhibited.

At this time, the infrared ray region preferably has the center of the transmission band (second wavelength band) described above within the band of from 780 nm to 950 nm and a certain band width.

Furthermore, the infrared ray region more preferably has the center of the transmission band (second wavelength band) within the band of from 800 nm to 900 nm and even more preferably has the center of the transmission band (second wavelength band) within the band of from 820 nm to 880 nm.

In this manner, in the case of applying the band-pass filter according to the seventh embodiment, for example, to a monitoring camera, it is sufficient to design such that the first transmission prevention band on the longer wavelength side than the visible light region that is a sub-transmission band is present on a longer wavelength side than the wavelength which is in the range of from 650 nm to 690 nm.

For example, in the case where light of from 700 nm to 750 nm is incident to an imaging element, the color reproducibility of the black image may be poor due to a red tinge.

In practice, since an optical filter which transmits a visible light region and prevents transmission of a near infrared ray region changes from transmission to transmission prevention at a certain gradient without the spectral characteristics being steeply changed, the lower limit of the first transmission prevention band (lower limit of the first wavelength band) is set to 650 nm in order to suppress light of 700 nm from being incident to an imaging element.

Here, as long as the optical filter is able to obtain a steep change as the spectral characteristics, it is possible to set the lower limit of the first transmission prevention band to, for example, 680 nm or 690 nm.

The spectral characteristics shown in FIG. 13 are a design example in which the first transmission prevention band is shifted to the short wavelength side up to the vicinity of 650 nm with respect to the spectral characteristics of FIG. 12, and are an example of a plural-bands-pass filter of which the wavelength λ is set to approximately 900 nm.

When carrying out automated design under a restriction of including two continuous layers of a high refractive index film with an optical film thickness of λ/4.5 or less and a low refractive index film with an optical film thickness of λ/4.5 or less so as to be able to obtain these spectral characteristics, provided is a structure of a multilayer film including an additional layer formed of two layers of a high refractive index film of λ/9 and a low refractive index film of λ/12 and an additional layer formed of two layers of a high refractive index film of λ/11 and a low refractive index film of λ/6.

In addition, according to the kind of the imaging elements, there is an imaging element having light sensitivity even in the vicinity of 1200 nm from a wavelength hand of 1100 nm or more. Therefore, the second transmission prevention band which is on the longer wavelength side than the transmission band (second wavelength band) is preferably applied up to 1100 nm and more preferably applied up to 1200 nm.

The spectral characteristics shown in FIG. 14 are a design example in which the second transmission prevention band is shifted to a long wavelength side up to the vicinity of 1200 nm with respect to the spectral characteristics in FIG. 12 and in which a short pass filter blocking up to 1200 nm is applied to the design example in FIG. 12.

In addition, it is also possible to obtain the characteristics as a whole shown in FIG. 15 by applying a characteristic of transmitting at a specific band to a sub-transmission band on the longer wavelength side than the wavelength λ of the transmission band.

When carrying out automated design under a restriction of including two continuous layers of a high refractive index film with an optical film thickness of λ/4.5 or less and a low refractive index film with an optical film thickness of λ/4.5 or less so as to be able to obtain these spectral characteristics, provided is a structure of a multilayer film including an additional layer formed of two layers of a high refractive index film of λ/10 and a low refractive index film of λ/7 and an additional layer formed of two layers of a high refractive index film of λ/7 and a low refractive index film of λ/9.

Here, in this example of a plural-bands-pass filter, the wavelength λ in this case is designed to be approximately 840 nm.

The present application is based on the Japanese Patent Application No. 2014-134852, filed on Jun. 30, 2014 and the contents thereof are included here as a reference.

### INDUSTRIAL APPLICABILITY

The embodiments described above are the most simplified examples of the present invention and the configuration, the number of films, or the like of the reflective layer and the spacer layer may be changed as long as an additional layer, which is formed of two continuous layers of a high refractive index film with an optical film thickness of λ/4.5 or less and a low refractive index film with an optical film thickness of λ/4.5 or less, is inserted in at least one boundary out of boundaries of the plurality of films.

In addition, it is possible to apply the band-pass filter of the present invention in various fields such as imaging equipment, measuring equipment, and communication equipment.

### DESCRIPTION OF REFERENCE NUMERALS AND SIGNS

100, 500 band-pass filter
110, 510 reflective layer
111, 511 high refractive index film
112, 512 low refractive index film
120, 520 spacer layer
122, 522 low refractive index film
130 additional layer
131 high refractive index film
132 low refractive index film

1. A band-pass filter comprising a plurality of films, having a reflective band centered on a predetermined wavelength λ and having a transmission band in a part within the reflective band,
wherein the band-pass filter further comprises an additional layer formed of two continuous layers of a high refractive index film with an optical film thickness of λ/4.5 or less and a low refractive index film with an optical film thickness of λ/4.5 or less, inserted in at least one boundary out of boundaries of the plurality of films.

2. The band-pass filter according to claim 1, comprising a plurality of the additional layers,
wherein each of the additional layers inserted in an arbitrary plurality of boundaries out of the boundaries, respectively.

3. The band-pass filter according to claim 1, comprising two or more sets of the additional layers continuously inserted in an arbitrary boundary.

4. The band-pass filter according to claim 1, wherein at least one boundary out of boundaries reflecting at the wavelength λ is a boundary interposed between two metal films, and
wherein the additional layer is inserted in the boundary interposed between the two metal films.

2. The band-pass filter according to claim 2, wherein at least one boundary out of boundaries reflecting at the wavelength λ is a boundary interposed between two metal films, and
wherein the additional layer is inserted in the boundary interposed between the two metal films.

6. The band-pass filter according to claim 3, wherein at least one boundary out of boundaries reflecting at the wavelength λ is a boundary interposed between two metal films, and
wherein the additional layer is inserted in the boundary interposed between the two metal films.

7. The band-pass filter according to claim 4, comprising a plurality of the boundaries each interposed between two metal films,
wherein at least one set of the additional layer is inserted in each of the plurality of the boundaries each interposed between two metal films.

8. The band-pass filter according to claim 5, comprising a plurality of the boundaries each interposed between two metal films,
wherein at least one set of the additional layer is inserted in each of the plurality of the boundaries each interposed between two metal films.

9. The band-pass filter according to claim 6, comprising a plurality of the boundaries each interposed between two metal films,
wherein at least one set of the additional layer is inserted in each of the plurality of the boundaries each interposed between two metal films.

10. The band-pass filter according to claim 1, which is imparted with a characteristic capable of transmitting a specific band in one or both sub-transmission bands on a shorter wavelength side and a longer wavelength side than the wavelength λ.

11. The band-pass filter according to claim 10, wherein the sub-transmission band is a visible light band, and
a first wavelength band on a longer wavelength side than the visible light band has, from the shorter wavelength side, a first transmission prevention band exhibiting transmission prevention characteristics, the transmission band, and a second transmission prevention band exhibiting transmission prevention characteristics.

12. The band-pass filter according to claim 11, wherein the first wavelength band is on 650 nm or more.

13. The band-pass filter according to claim 11, wherein the second transmission prevention band is on 1100 nm or more.

14. The band-pass filter according to claim 11, wherein the transmission band has a central wavelength within a range of from 780 nm to 950 nm.

15. The band-pass filter according to claim 11, wherein the transmission band has a band width of 200 nm or less.

16. The band-pass filter according to claim 11, having a transmittance in the visible light region and a transmittance in the transmission band both being 60% or more.

11. band-pass filter according to claim 11, having a transmittance in the first transmission prevention band and a transmittance in the second transmission prevention band both being 30% or less.

18. The band-pass filter according to claim 1, comprising a substrate and a multilayer film on one main surface of the substrate,
wherein the multilayer film comprises the additional layer.
